(19) United States
(12) Patent Application Publication
(10) Pub. No.: US 2017/0279730 A1
(43) Pub. Date: Sep. 28, 2017

(54) PACKET COLORING IN WIRELESS COMMUNICATION SYSTEMS

(71) Applicants: Alcatel-Lucent USA Inc., Murray Hill, NJ (US); Alcatel Lucent, Paris (FR)

(72) Inventors: Doru Calin, Manalapan, NJ (US); Bongho Kim, Morganville, NJ (US); Bilgehan Erman, Weehawken, NJ (US); Francis Bourriaud, Longjumeau (FR)

(21) Appl. No.: 15/081,414

(22) Filed: Mar. 25, 2016

(51) Int. Cl. H04L 12/863; H04L 12/861

(52) U.S. Cl. CPC H04L 47/6215; H04L 49/9005

(57) ABSTRACT

A buffer stores only packets in one or more high-priority traffic flows in a first portion. The size of the first portion is determined based on an estimated maximum volume of traffic in the at least one high-priority traffic flow. The buffer stores packets in either the one or more high-priority traffic flows or one or more low-priority traffic flows in a second portion. The buffer stores only packets in the one or more low-priority traffic flows in a third portion. A processor marks the packets in the first portion and the second portion with a high-priority color prior to transmission of the packets. The processor marks the packets in the third portion with a low-priority color prior to transmission of the packets.

### BACKGROUND

Field of the Disclosure

The present disclosure relates generally to wireless communication systems and, more particularly, to transmitting packets in wireless communication systems.

Description of the Related Art

Wireless communication systems typically include multiple network domains, which may be owned and operated by different operators. For example, wireless communication travels over an air interface from a user equipment to an access node and over a backhaul network from the access node to entities in the mobile core network such as a serving gateway (SGW) and a mobility management entity (MME). A first operator may operate a mobile network domain including the air interface, access node, and a mobile core network. A second operator may operate a backhaul network domain including the routers in the backhaul network. The first operator contracts with a second operator for backhaul bandwidth in the backhaul network domain according to a binding Service Level Agreement (SLA) that guarantees bandwidth in the backhaul network domain to the first operator (e.g., the second operator may guarantee a committed information rate, or CIR, to the first operator) and provides best effort communication for additional bandwidth (e.g., at an excess information rate, or EIR). Edge routers in the backhaul network domain include policing functions that enforce the CIR and EIR indicated in the SLA for the first operator.

### SUMMARY

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In some embodiments, a method is provided that includes selecting, from one or more traffic flows, only packets in one or more high-priority traffic flows and storing the selected packets in a first portion of a buffer. A size of the first portion is determined based on an estimated maximum volume of traffic in the one or more high-priority traffic flows. The method also includes storing packets in either the one or more high-priority traffic flows or one or more low-priority traffic flows in a second portion of the buffer and storing only packets in the one or more low-priority traffic flows in a third portion of the buffer. The method further includes marking the packets in the first portion and the second portion with a high-priority color and marking the packets in the third portion with a low-priority color.

In some embodiments, an apparatus is provided that includes a buffer to store only packets in one or more high-priority traffic flows in a first portion. The size of the first portion is determined based on an estimated maximum volume of traffic in the one or more high-priority traffic flows. The buffer is to store packets in either the one or more high-priority traffic flows or one or more low-priority traffic flows in a second portion. The buffer is to store only packets in the one or more low-priority traffic flows in a third portion. The apparatus also includes a processor to mark the packets in the first portion and the second portion with a high-priority color prior to transmission of the packets and to mark the packets in the third portion with a low-priority color prior to transmission of the packets.

In some embodiments, a non-transitory computer readable medium embodying a set of executable instructions is provided. The set of executable instructions is to manipulate a processor to select, from one or more traffic flows, only packets in one or more high-priority traffic flows and store the selected packets in a first portion of a buffer. A size of the first portion is determined based on an estimated maximum volume of traffic in the one or more high-priority traffic flows. The processor is also to store packets in either the one or more high-priority traffic flows or one or more low-priority traffic flows in a second portion of the buffer and store only packets in the one or more low-priority traffic flows in a third portion of the buffer. The processor is further to mark the packets in the first portion and the second portion with a high-priority color and marking the packets in the third portion with a low-priority color.

Some embodiments include determining the size of the first portion based on packets received in the one or more high-priority traffic flows within a previous time interval. Some embodiments include determining the size of the first portion based on a sum over the one or more high-priority traffic flows of a product of a maximum number of packets and the size of the packets received in the one or more high-priority traffic flows within the previous time interval. Some embodiments include determining the size of the first portion based on a maximum value of a plurality of buffer storage capacities used by the one or more high-priority traffic flows in a plurality of subintervals of the previous time interval.

Some embodiments include modifying the size of the first portion in response to a change in a measured value of a buffer storage capacity used by the one or more high-priority traffic flows. Some embodiments include decreasing the size of the first portion to the measured value plus a first margin in response to the measured value being less than a previously measured value of the buffer storage capacity. Some embodiments include increasing the size of the first portion to the measured value plus a second margin in response to the measured value being greater than a previously measured value of the buffer storage capacity.

Some embodiments include transmitting marked packets from the first portion and the second portion of the buffer in a burst determined by a committed information rate and a committed burst size and transmitting marked packets from the third portion of the buffer in a burst determined by an excess information rate and an excess burst size.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a wireless communication system according to some embodiments.

FIG. 2 is a block diagram of a wireless communication system that implements dual rate traffic shaping according to some embodiments.

FIG. 3 is a block diagram of a buffer for implementation with a dual rate traffic shaper that has packet coloring enabled according to some embodiments.

FIG. 4 is a block diagram of a traffic shaper according to some embodiments.

FIG. 5 is a diagram that illustrates a buffer filled by packets from a high-priority traffic flow and a low-priority traffic flow according to some embodiments.

FIG. 6 illustrates a traffic volume profile, a series of committed information rate (CIR) packet bursts, and a series of excess information rate (EIR) packet bursts as a function of time according to some embodiments.

FIG. 7 is a block diagram of a wireless communication system that includes multiple mobile core networks according to some embodiments.

FIG. 8 is a diagram that illustrates a buffer filled by packets from a high-priority traffic flow and a low-priority traffic flow according to some embodiments.

FIG. 9 illustrates a traffic volume profile, a series of CIR packet bursts, and a series of EIR packet bursts as a function of time according to some embodiments.

FIG. 10 is a flow diagram of a method for determining an initial size of a portion of a buffer reserved for packets in high-priority traffic flows according to some embodiments.

FIG. 11 is a flow diagram of a method for dynamically modifying a size of a portion of a buffer reserved for packets in high-priority traffic flows according to some embodiments.

FIG. 12 is a flow diagram of a method for buffering packets in low-priority traffic flows according to some embodiments.

FIG. 13 is a flow diagram of a method for buffering packets in high-priority traffic flows according to some embodiments.

FIG. 14 illustrates high-priority VoIP traffic and low-priority best effort traffic according to some embodiments.

FIG. 15 illustrates traffic shaping of high-priority VoIP traffic and low-priority best effort traffic using a buffer that does not reserve space exclusively for the high-priority VoIP traffic according to some embodiments.

FIG. 16 illustrates the total numbers of shaped high-priority VoIP packets and low-priority best effort packets output from a traffic shaper that uses a buffer that does not reserve space exclusively for the high-priority VoIP traffic according to some embodiments.

FIG. 17 illustrates the total numbers of shaped high-priority VoIP packets and low-priority best effort packets output from a traffic shaper that uses a buffer that reserves space exclusively for the high-priority VoIP traffic according to some embodiments.

### DETAILED DESCRIPTION

Access nodes include shaping functions that perform traffic shaping on packets that are transmitted from the mobile network domain to the backhaul network domain. As used herein, the term “traffic shaping” refers to the process of storing packets received at an access node and then transmitting the stored packets in bursts that have a size and frequency determined by a set of traffic shaping parameters such as a burst size and an information rate. The shaping function can use packet coloring to mark packets with differentiating colors that indicate different priority levels, e.g., voice packets that require low delay and jitter may be colored green to indicate high-priority and best effort data packets that can tolerate delays and jitter may be colored yellow to indicate low-priority. Routers in the backhaul network use the packet colors to identify higher priority packets and prioritize these packets for transmission, particularly when the routers are congested. However, packet colors do not always correctly map to the guaranteed bandwidth (or committed information rate, CIR) and the best effort bandwidth (or excess information rate, EIR) supported by the backhaul network domain. For example, shaping functions include “leaky bucket” buffers to hold packets as they are received at a first rate. The buffered packets are then transmitted to the backhaul network at a second rate. As long as the buffer receives less than a threshold amount of information (the accepted committed burst size, CBS*), the shaping function can color all the packets green and output them in shaped bursts that have a committed burst size (CBS) and are spaced out to produce a rate that is less than or equal to the CIR. If packets arrive more quickly so that the buffer fills to above the threshold CBS*, the excess packets are colored yellow. Excess packets are then shaped in bursts of excess burst size (EBS) and transmitted using the best effort bandwidth at a rate up to the EIR. Thus, depending on the arrival rate of packets and their order of arrival, voice packets may be colored yellow and data packets may be colored green, thereby assigning an undesirably low-priority to the voice packets, which may cause voice packets to be dropped by congested routers in the backhaul network.

The likelihood that packets in high-priority traffic flows generated by a traffic shaper in a first network domain are dropped while traversing a second network domain is reduced by reserving a first portion of a buffer in the traffic shaper to receive the high-priority traffic flows. A second portion of the buffer receives packets in either the high-priority traffic flows or low-priority traffic flows and a third portion of the buffer receives only low-priority traffic flows. The traffic shaper marks packets in the first and second portions with a high-priority color and marks packets in the third portion with a low-priority color. The size of the first portion of the buffer is dynamically determined based on an estimated maximum volume of traffic in the high-priority traffic flows. In some embodiments, the size of the first portion is equal to a sum over the high-priority traffic flows of a product of the maximum number of packets and the size (in bytes) of the packets received in the high-priority traffic flows within a predetermined time interval or set of time intervals. The size of the first portion may be determined periodically (or at other intervals) so that the size of the first portion increases or decreases in response to the corresponding changes in the volume of traffic in the high-priority flows. Margins may be added to the size of the first portion to create a hysteresis to account for sudden traffic fluctuations. The size of the combined first and second portions of the buffer is determined by a Service Level Agreement (SLA) that indicates a committed information rate (CIR) provided by the second network domain. The size of the third portion of the buffer is determined by an excess information rate (EIR) indicated by the SLA. The traffic shaper transmits packets in the first and second portions in bursts that have a committed burst size (CBS) determined by the SLA and transmits packets in the third portion in bursts that have an excess burst size (EBS) determined by the SLA.

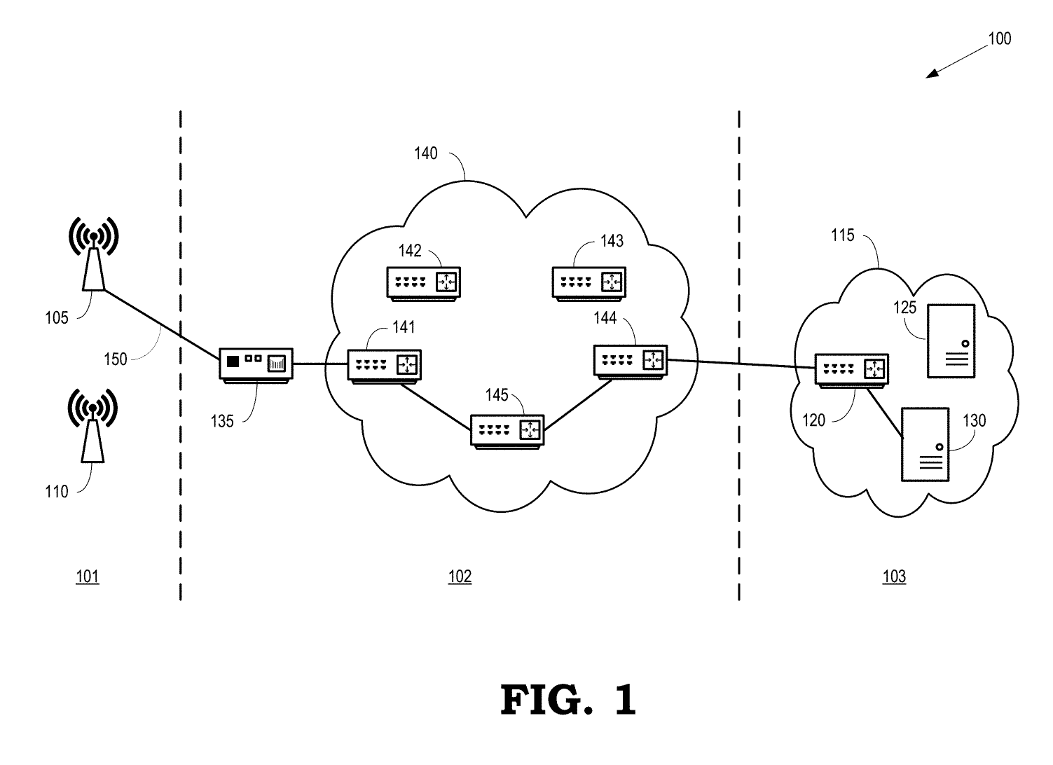

FIG. 1 is a block diagram of a wireless communication system 100 according to some embodiments. The wireless communication system 100 includes a mobile network domain 101, 103 and a backhaul network domain 102. The portion 101 of the mobile network domain includes access nodes 105, 110 that provide wireless connectivity to one or more user equipment (not shown) over corresponding air interfaces. The portion 103 of the mobile network domain includes a mobile core network 115 that is accessed via a gateway router 120. The mobile core network 115 also includes a serving gateway (SGW) 130 that implements a data plane stack to support user plane interfaces with the access nodes 105, 110. The SGW 130 also implements a control plane stack to support an interface with a mobility management entity (MME) 125 in the mobile core network 115. The MME 125 implements control plane stacks to support packet interfaces with the access nodes 105, 110 and the SGW 130, e.g., according to the Internet Protocol (IP), the stream control transmission protocol (SCTP), and the S1 application part (S1AP) protocol.

The backhaul network domain 102 includes an aggregation router 135 that aggregates packets received from the access nodes 105, 110 and provides them to a backhaul network 140. The aggregation router 135 may also receive packets from the backhaul network 140 and distribute them to the appropriate access nodes 105, 110, e.g., based on addresses or identifiers of user equipment associated with the access nodes 105, 110 that are included in the packet headers. The backhaul network 140 includes routers 141, 142, 143, 144, 145, which are referred to collectively as “the routers 141-145.” The routers 141-145 are interconnected using technology such as cable, microwave transmissions, or optical fiber. The routers 141-145 convey packets through the backhaul network 140, e.g., based on addresses or identifiers included in the packet headers. In the interest of clarity, only the interconnections that are used to convey packets between the routers 141-145 for one embodiment are illustrated in FIG. 1. For example, the interconnections that establish a route 150 from the access node 105 to the SGW 130 are illustrated in FIG. 1 by a solid line connecting the various entities along the route 150. The backhaul network 140 may be implemented in accordance with the specifications of a Metropolitan Ethernet Network (MEN).

In the illustrated embodiment, the mobile network domain 101, 103 and the backhaul network domain 102 are owned or operated by different operators, which are referred to herein as operator A and operator B, respectively. Operator A relies on the backhaul network domain 102 to convey packets between the portions 101, 103 of the mobile network domain. Operator A therefore contracts with operator B for bandwidth in the backhaul network domain 102. For example, operator A and operator B may enter into binding Service Level Agreements (SLAs) that specify the metrics of a bandwidth profile that the operator B agrees to provide to support packets transmitted between the portions 101, 103 of the mobile network domain. The metrics may include a committed information rate (CIR), a committed burst size (CBS), an excess information rate (EIR), and an excess burst size (EBS). The CIR indicates a guaranteed bandwidth in the backhaul network domain 102 that must be provided to convey packets between the portions 101, 103 of the mobile network domain. The CBS indicates the maximum size (in bytes) of a committed burst that must be supported by the backhaul network domain 102. The frequency of committed bursts is determined by the CBS and the CIR so that the average bit rate does not exceed the CIR. The EIR indicates additional bandwidth that is available to convey best effort packets through the backhaul network domain 102. The EIR bandwidth is not guaranteed to be available at any particular time. The EBS indicates the maximum size (in bytes) of an excess burst that is supported by the backhaul network domain 102. The frequency of excess bursts is determined by the EBS and the EIR so that the average bit rate does not exceed the EIR. Operator A typically pays a higher price per bit for committed information than for excess information.

Packets in the mobile network domain 101, 103 may be assigned to different categories to provide differentiation across the categories. For example, the packets may be assigned to different Quality of Service (QoS) categories that are indicated by QoS class indicators (QCIs). The QCIs range from 1 to 9 and different values of the QCI indicate whether the packet is to be transmitted using a guaranteed bit rate resource or a non-guaranteed bit rate resource. The QCI values also indicate relative priorities, packet delay budgets, tolerance for packet loss, and the like. The backhaul network 102 may be colorblind or may support color differentiation between packets. A colorblind backhaul network 102 treats all packets equally, regardless of the QCI that may be assigned to the packets in the mobile network domain 101, 103. A backhaul network 102 that supports color differentiation can handle packets that are marked with different colors using different priorities. For example, packets may be marked “green” in the mobile network domain 101 to indicate a higher priority that is recognized by the routers 141-145 in the backhaul network 140. Packets may be marked “yellow” in the mobile network domain 101 to indicate a lower priority, relative to green packets, which is recognized by the routers 141-145 in the backhaul network 140. In the interest of clarity, packet coloring is discussed herein in the context of two colors but some embodiments may mark packets with more colors to further differentiate between different priority levels. A traffic shaper (not shown in FIG. 1) may be implemented in the mobile network domain 101 and may be used to mark packets with high-priority colors and low-priority colors.

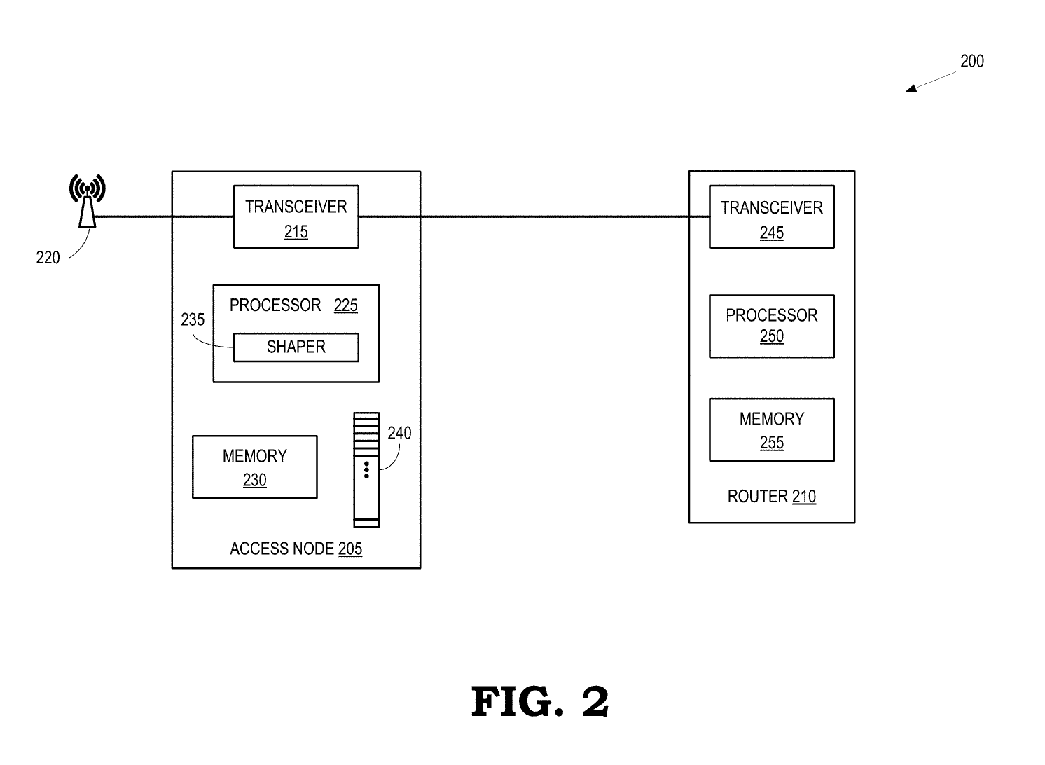

FIG. 2 is a block diagram of a wireless communication system 200 that implements dual rate traffic shaping according to some embodiments. The wireless communication system 200 includes an access node 205, which may be used to implement some embodiments of the access nodes 105, 110 shown in FIG. 1. The wireless communication system 200 also includes a router 210, which may be used to implement some embodiments of the routers 141-145 shown in FIG. 1.

The access node 205 includes a transceiver 215 that is connected to an antenna 220 for transmitting and receiving signals over an air interface. The transceiver 215 may also be used to transmit or receive information over a connection with the router 210. The access node 205 also includes a processor 225 and a memory 230. The processor 225 may be used to execute instructions stored in the memory 230 and to store information in the memory 230 such as the results of the executed instructions. Some embodiments of the processor 225 implement a shaper 235 to perform dual rate traffic shaping that “shapes” packets into high-priority bursts (e.g., bursts of packets that are marked with the color green) and low-priority bursts (e.g., bursts of packets that are marked with the color yellow). For example, received packets may be stored in a buffer 240 and then selectively marked with high-priority or low-priority colors, as discussed herein. The transceiver 215 transmits the shaped packets from the buffer 240 to the router 210.

The router 210 includes a transceiver 245 to transmit or receive packets over an interface with the transceiver 215 in the access node 205. The transceiver 245 may also be used to transmit or receive packets over interfaces or interconnections with other routers (not shown in FIG. 2). The router 210 also includes a processor 250 and a memory 255, which may be used to store information and instructions that may be executed by the processor 250. Some embodiments of the processor 250 selectively transmit one or more packets based on marked colors of the packets, as discussed herein.

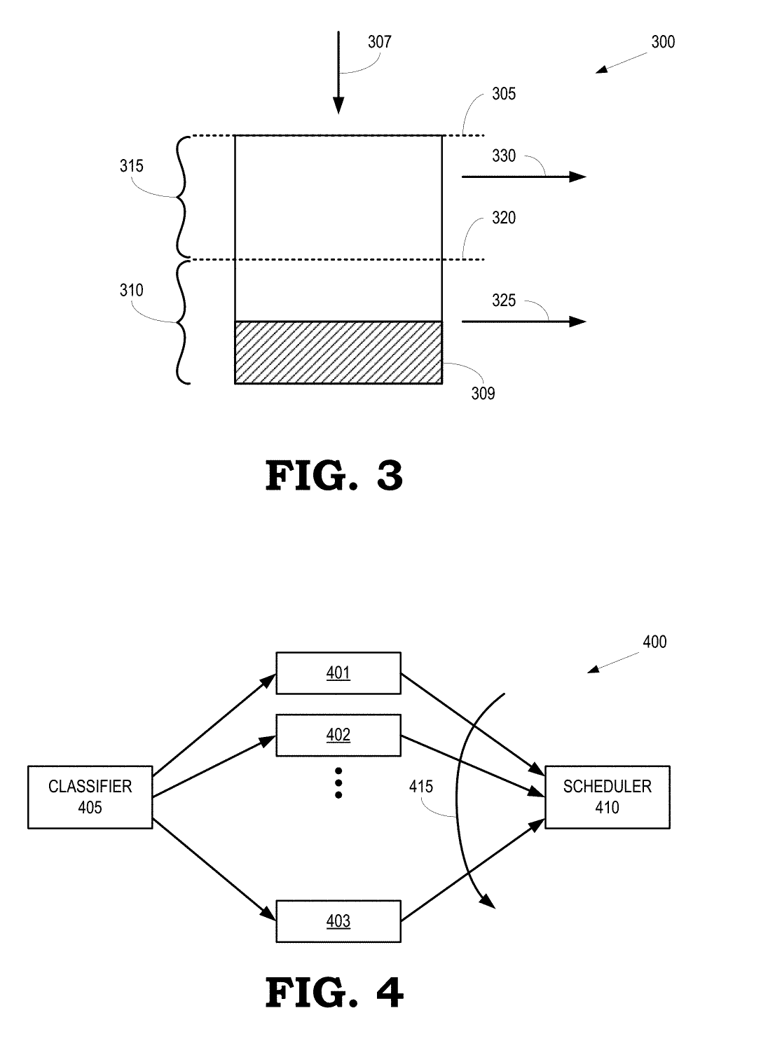

FIG. 3 is a block diagram of a buffer 300 for implementation with a dual rate traffic shaper that has packet coloring enabled according to some embodiments. The buffer 300 may be used to implement some embodiments of the buffer 240 shown in FIG. 2. The buffer 300 has a maximum occupancy 305, which may correspond to an amount of information that may be transmitted between a mobile network domain and a backhaul network domain in accordance with an SLA between operators of the mobile network domain and the backhaul network domain. In some embodiments, the maximum occupancy 305 is determined by a peak information rate (PIR) that is equal to the sum of a CIR and an EIR indicated by the SLA.

The buffer 300 is subdivided into a first portion 310 and a second portion 315. The first portion 310 is configured to store an amount of information that corresponds to a CIR defined by the SLA, as indicated by the threshold 320. The threshold 320 may be referred to as an accepted CBS*. Thus, packets that are stored in the first portion 310 of the buffer 300 are marked with a high-priority color (such as green) and may be transmitted in a burst of a size up to the CBS indicated by the SLA. The transmitted high-priority burst is indicated by the arrow 325. The second portion 315 is configured to store an amount of information that corresponds to an EIR indicated by the SLA. Thus, packets that are stored in the second portion 315 of the buffer 300 are marked with a low-priority color (such as yellow) and may be transmitted in a burst of a size up to the EBS indicated by the SLA. The transmitted low-priority burst is indicated by the arrow 330.

The buffer 300 may receive packets, such as packets received over an air interface, as indicated by the arrow 307. The buffer occupancy is indicated by the hatched region 309 of the buffer 300. In the illustrated embodiment, packets are stored in the buffer 300 from bottom to top in the order they are received. Thus, all packets (of any priority) that arrive at the buffer 300 while the buffer occupancy is less than the threshold 320 are marked with a high-priority color prior to transmission out of the buffer 300. Packets that arrive at the buffer 300 while the buffer occupancy is greater than the threshold 320 but less than the maximum occupancy 305 are marked with a low-priority color prior to transmission out of the buffer 300. Packets that arrive at the buffer 300 when the buffer occupancy is at the maximum occupancy 305 are dropped.

FIG. 4 is a block diagram of a traffic shaper 400 according to some embodiments. The traffic shaper 400 may be used to implement some embodiments of the shaper 235 shown in FIG. 2. The traffic shaper 400 includes a classifier 405 that receives packets and directs the packets to one of a plurality of queues 401, 402, 403, which are referred to collectively as “the queues 401-403.”

Each of the queues 401-403 corresponds to a different priority level. The classifier 405 directs the packets to the appropriate queue 401-403 based on information identifying the priority of the packet. For example, the classifier 405 may direct high-priority voice packets to the high-priority queue 401 and low-priority best effort data packets to the low-priority queue 403. Although three queues 401-403 are shown in FIG. 4, some embodiments of the traffic shaper 400 may implement more or fewer queues that correspond to more or fewer priority levels. For example, two queues may be used in systems that implement the buffer 300 that includes the first portion 310 and the second portion 315 shown in FIG. 3.

The traffic shaper 400 includes a scheduler 410 that schedules packets from the queues 401-403 based on their corresponding priorities. In the illustrated embodiment, the scheduler 410 preferentially schedules packets from the queue 401 because they are associated with a higher priority. The scheduler 410 gives correspondingly lower preferences to scheduling packets from the queues 402, 403, as indicated by the arrow 415.

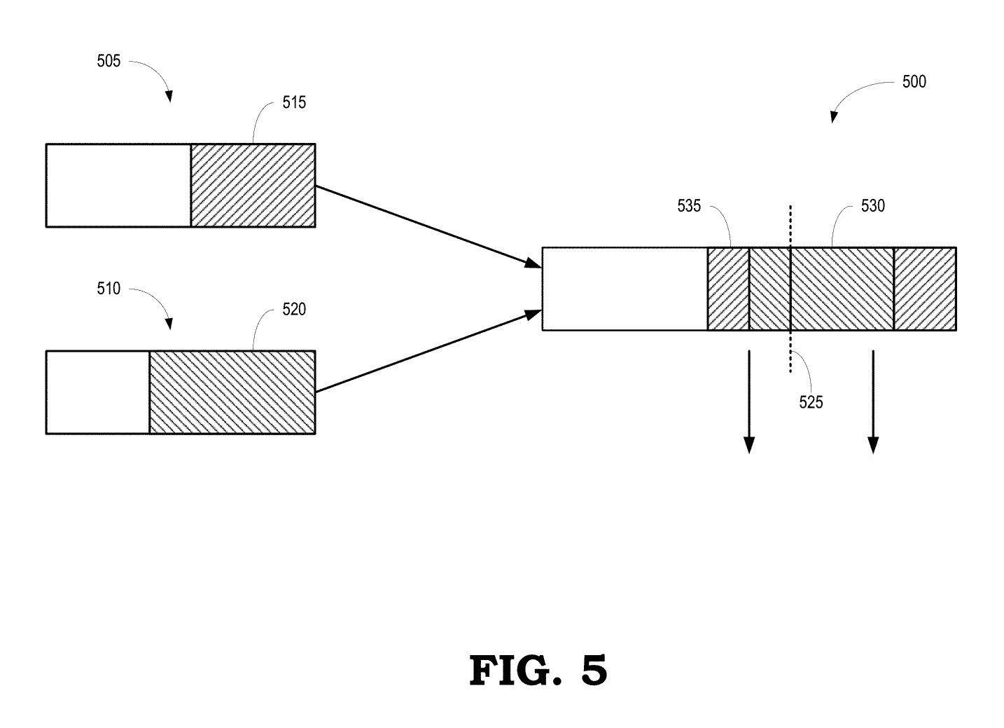

FIG. 5 is a diagram that illustrates a buffer 500 filled by packets from a high-priority traffic flow 505 and a low-priority traffic flow 510 according to some embodiments. The buffer 500 may be used to implement some embodiments of the buffer 240 shown in FIG. 2 or the buffer 300 shown in FIG. 3. Some embodiments of the high-priority traffic flow 505 include voice packets 515 (indicated by the hatching that rises left to right) such as packets that are generated and transmitted according to a Voice over Internet Protocol (VoIP). Some embodiments of the low-priority traffic flow include best effort data packets 520 (indicated by the hatching that falls left to right). The buffer 500 is divided into two portions by a threshold 525 such as a CBS* defined by an SLA. Packets in the portion to the left of the threshold 525 are marked with a low-priority color and are transmitted using EBS bursts and according to EIR. Packets in the portion to the right of the threshold 525 are marked with a high-priority color and are transmitted using CBS bursts and according to CIR.

Packets from the high-priority traffic flow 505 and the low-priority traffic flow 510 are stored in the buffer 500 in the order in which they are received. Thus, depending on their order of arrival, packets in the high-priority flow may be stored in the left-hand portion of the buffer 500 and marked with the low-priority color for transmission as EBS bursts, while packets in the low-priority flow may be stored in the right-hand portion of the buffer 500 and marked with the high-priority color for transmission as CBS bursts. For example, the best effort packets 530 are marked with the high-priority color and the voice packets 535 are marked with the low-priority color. Marking the high-priority packets 535 with a low-priority color may lead to undesirable packet losses, particularly when routers in the backhaul network become congested.

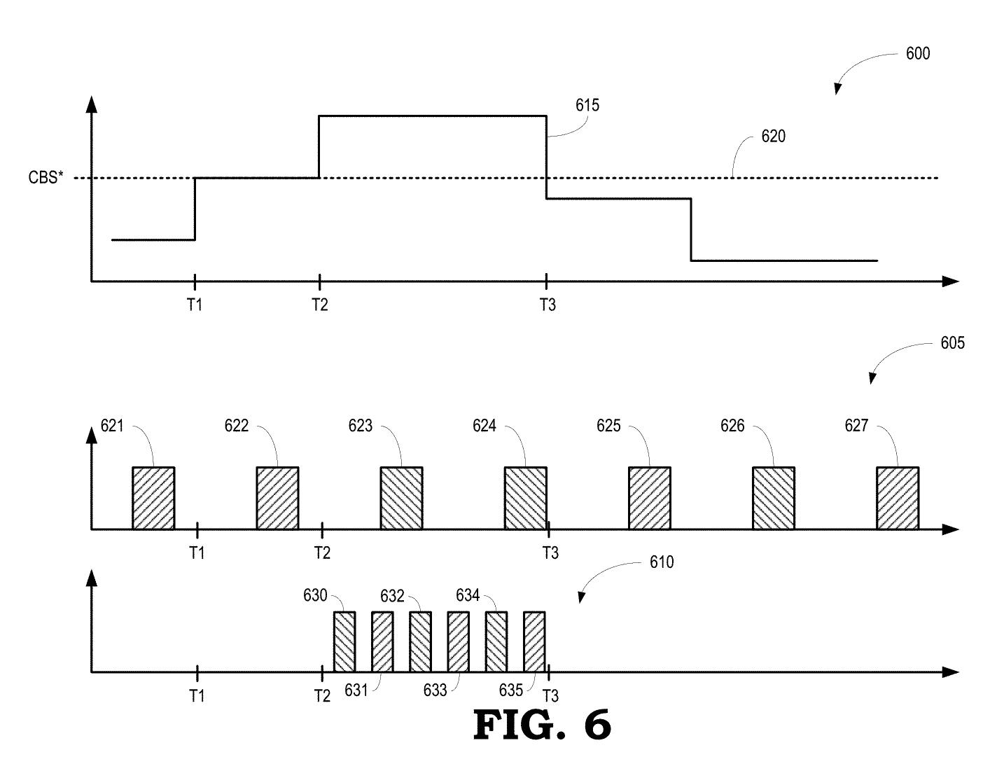

FIG. 6 illustrates a traffic volume profile 600, a series 605 of CIR shaped packet bursts, and a series 610 of EIR shaped packet bursts as a function of time according to some embodiments. The traffic volume profile 600 illustrates a buffer occupancy 615 of a buffer associated with a traffic shaper, such as the buffer 240 associated with the shaper 235 shown in FIG. 2, the buffer 300 shown in FIG. 3, or the buffer 500 shown in FIG. 5. A threshold 620 indicates the maximum buffer occupancy that can be used to generate CBS-sized packet bursts for transmission using the CIR credit of a backhaul network, as discussed herein.

At time T<T1, the buffer occupancy 615 is less than the threshold 620 and all the packets received by the buffer in either high-priority traffic flows or low-priority traffic flows can be transmitted in CBS packets that are marked with a high-priority color such as green. For example, a burst 621 is part of the series 605 that is marked with the high-priority color and transmitted using the CIR credit. In the illustrated embodiment, the burst 621 includes packets from a high-priority packet flow such as a voice packet flow, as indicated by the hatching that rises left to right. However, the burst 621 may also include some packets from a low-priority packet flow depending on the packets that are in the buffer when the burst 621 is formed by the traffic shaper.

At time T1<T<T2, the buffer occupancy 615 is equal to the threshold 620 and all the packets received by the buffer in either high-priority traffic flows or low-priority traffic flows can be transmitted in CBS packets that are marked with a high-priority color such as green. For example, a burst 622 is part of the series 605 that is marked with the high-priority color and transmitted using the CIR credit. In the illustrated embodiment, the burst 622 includes packets from a high-priority packet flow such as a voice packet flow, as indicated by the hatching that rises left to right. However, the burst 622 may also include some packets from a low-priority packet flow depending on the packets that are in the buffer when the burst 622 is formed by the traffic shaper.

At time T2<T<T3, the buffer occupancy 615 is greater than the threshold 620 and only a subset of the packets received by the buffer in either high-priority traffic flows or low-priority traffic flows can be transmitted in CBS packets that are marked with a high-priority color such as green. The remainder of the packets is transmitted in EBS packets that are marked with a low-priority color such as yellow. For example, bursts 623, 624 are part of the series 605 that is marked with the high-priority color and transmitted using the CIR credit. Bursts 630, 631, 632, 633, 634, 635 (collectively referred to as “the bursts 630-635”) are part of the series 610 that is marked with the low-priority color and transmitted using the EIR credit. In the illustrated embodiment, the bursts 623, 624 include packets from a low-priority packet flow such as a best effort packet flow, as indicated by the hatching that falls left to right. Moreover, the bursts 631, 633, 635 include packets from the high-priority packet flow. Thus, packets from the high-priority packet flow are marked with the low-priority color and transmitted using the EIR credit while packets from the low-priority packet flow are marked with the high-priority color and transmitted using the CIR credit.

Routers in the backhaul network preferentially handle packets that are marked with the high-priority color. Thus, packets that are marked with the low-priority color may be dropped by routers that become congested. The bursts 631, 633, 635 may therefore be dropped during periods of congestion even though they are part of the high-priority packet flow because they have been marked with the low-priority color and transmitted using the EIR credit. These packet losses may be reduced or eliminated by marking the high-priority packets 631, 633, 636, as discussed below.

At time T>T3, the buffer occupancy 615 is below the threshold 620 and all the packets received by the buffer in either high-priority traffic flows or low-priority traffic flows can be transmitted in CBS packets that are marked with a high-priority color such as green. For example, bursts 625, 626, 627 are part of the series 605 that is marked with the high-priority color and transmitted using the CIR credit. In the illustrated embodiment, the burst 625 includes packets from a high-priority packet flow, the burst 626 includes packets from a low-priority packet flow, and the burst 627 includes packets from the high-priority packet flow. However, each of the bursts 625-627 may include a mixture of packets from the high-priority and low-priority packet flows depending on the packets that are in the buffer when the bursts 625-627 are formed by the traffic shaper.

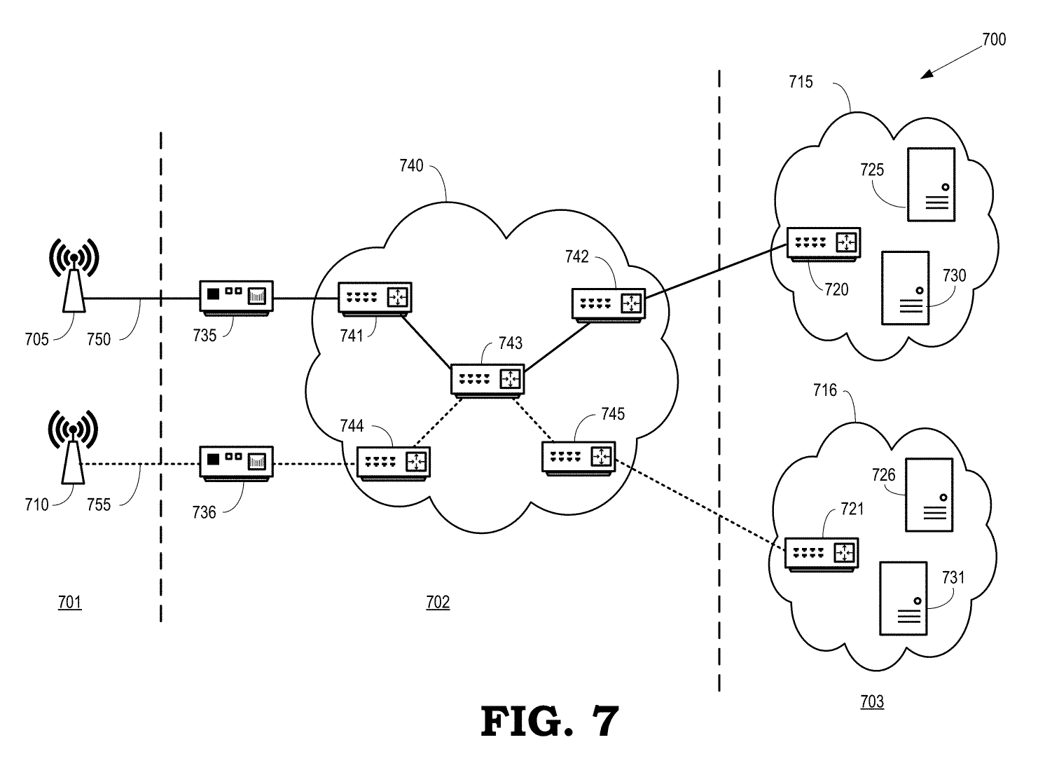

FIG. 7 is a block diagram of a wireless communication system 700 that includes multiple mobile core networks according to some embodiments. The wireless communication system 700 includes a mobile network domain 701, 703 and a backhaul network domain 702. The portion 701 of the mobile network domain includes access nodes 705, 710 that provide wireless connectivity to one or more user equipment (not shown) over corresponding air interfaces. The portion 703 of the mobile network domain includes two mobile core networks 715, 716 that are accessed via corresponding gateway routers 720, 721. The mobile core network 715, 716 also include SGWs 730, 731 and MMES 725, 726.

The backhaul network domain 702 includes aggregation routers 735, 736 that aggregate packet received from the corresponding access nodes 705, 710 and provide them to a backhaul network 740. The aggregation routers 735, 736 may also receive packets from the backhaul network 740 and distribute them to the appropriate access nodes 705, 710, e.g., based on addresses or identifiers of user equipment associated with the access nodes 705, 710 that are included in the packet headers. The backhaul network 740 includes routers 741, 742, 743, 744, 745, which are referred to collectively as “the routers 741-745.” The routers 741-745 are interconnected using technology such as cable, microwave transmissions, or optical fiber. The routers 741-745 convey packets through the backhaul network 740, e.g., based on addresses or identifiers included in the packet headers.

The mobile network domain 701, 703 and the backhaul network domain 702 may be owned or operated by different operators. Furthermore, different operators may own and operate different mobile networks within the wireless communication system 700. For example, operator A may own and operate a mobile network that includes the access node 705 and the mobile core network 715 and operator C may own and operate a mobile network that includes the access node 710 and the mobile core network 716. Operator B may own and operate the backhaul network 740. Operators A and C rely on the backhaul network domain 702 to convey packets between the portions 701, 703 of the mobile network domain. Operators A and C therefore contract with operator B for bandwidth in the backhaul network domain 702. For example, operator A and operator C may enter into binding SLAs with operator B that specify respective CIRs, CBSs, EIRs, and EBSs.

In the illustrated embodiment, the backhaul network domain 702 provides a first route 750 (indicated by a solid line) from the access node 705 to the gateway 720 in the corresponding mobile core network 715. The backhaul network domain 702 also provides a second route 755 (indicated by a dotted line) from the access node 710 to the gateway 721 in the corresponding mobile core network 716. Both of the routes 750, 755 convey packets through the router 743 in the backhaul network 740. The router 743 may therefore become congested during periods of high usage by user equipment associated with the access nodes 705, 710. The backhaul network domain 702 only guarantees bandwidth sufficient to carry the contracted CIRs for the operators of the access nodes 705, 710 and the corresponding mobile core networks 715, 716. Thus, any additional traffic that is conveyed using the EIR credit may be dropped during congested periods. For example, the router 743 may only have sufficient resources to guarantee the CIRs for packets conveyed along the routes 750, 755 and may drop one or more packets conveyed along the routes 750, 755 using the EIR credit. The likelihood that packets in high-priority traffic flows are dropped while traversing a second network domain can be reduced by reserving a portion of a buffer dedicated to the CIR credit for receiving the high-priority traffic flows.

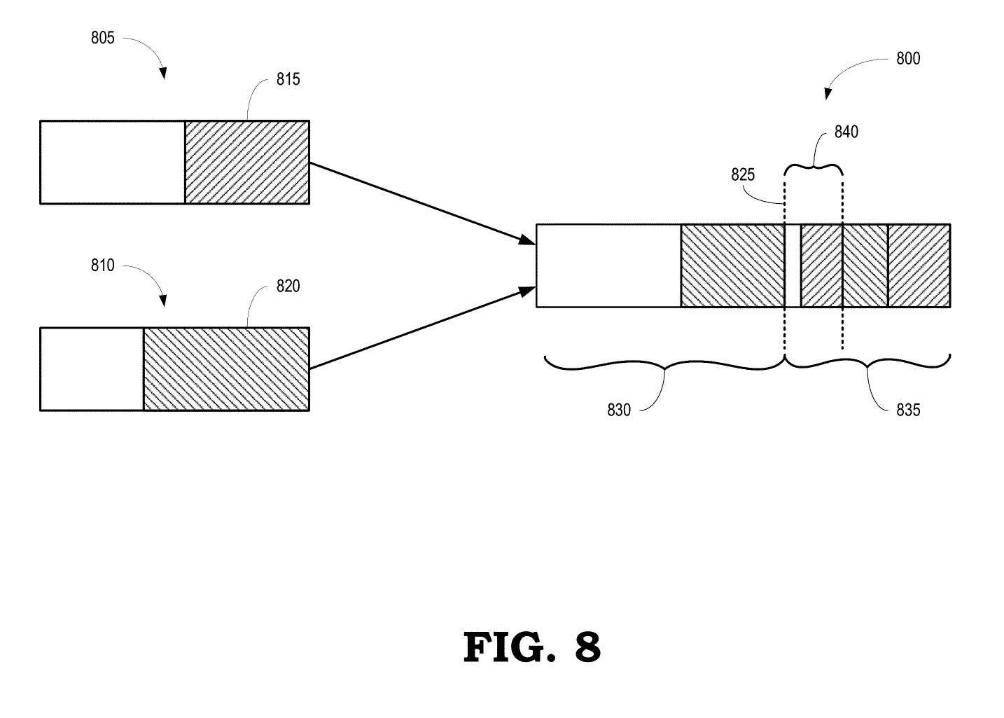

FIG. 8 is a diagram that illustrates a buffer 800 filled by packets from a high-priority traffic flow 805 and a low-priority traffic flow 810 according to some embodiments. The buffer 800 may be used to implement some embodiments of the buffer 240 shown in FIG. 2 or the buffer 300 shown in FIG. 3. Some embodiments of the high-priority traffic flow 805 include voice packets 815 (indicated by the hatching that rises left to right) such as packets that are generated and transmitted according to a Voice over Internet Protocol (VoIP). Some embodiments of the low-priority traffic flow include best effort data packets 820 (indicated by the hatching that falls left to right). The buffer 800 is divided into two portions by a threshold 825 such as a CBS* defined by an SLA. Packets in the portion 830 to the left of the threshold 825 are marked with a low-priority color and are transmitted using EBS bursts and according to EIR. Packets in the portion 835 to the right of the threshold 825 are marked with a high-priority color and are transmitted using CBS bursts and according to CIR.

The CBS portion 835 is further partitioned to reserve a portion 840 for packets 815 in the high-priority traffic flow 805. Only packets 815 in the high-priority traffic flow 805 are stored in the reserved portion 840. In some embodiments, techniques such as call admission control are used to guarantee that the buffer occupancy needed to store packets 815 in the high-priority flows 805 remains less than or equal to the size of the portion 835. The buffer 800 is therefore partitioned into three portions: the portion 830 that only receives packets 820 from the low-priority traffic flows 810, the portion 840 that is reserved for packets in the high-priority traffic flow 805, and the remaining part of the portion 835 that may receive packets 815, 820 from either the high-priority traffic flows 805 or the low-priority traffic flows 810. Reserving the portion 840 ensures that the packets 815 in the high-priority traffic flow 805 are marked with the high-priority color for transmission as CBS bursts using the CIR credit. In some embodiments, the size of the portion 840 is determined dynamically based upon estimates of the buffer occupancy for high-priority packets 815, as discussed below.

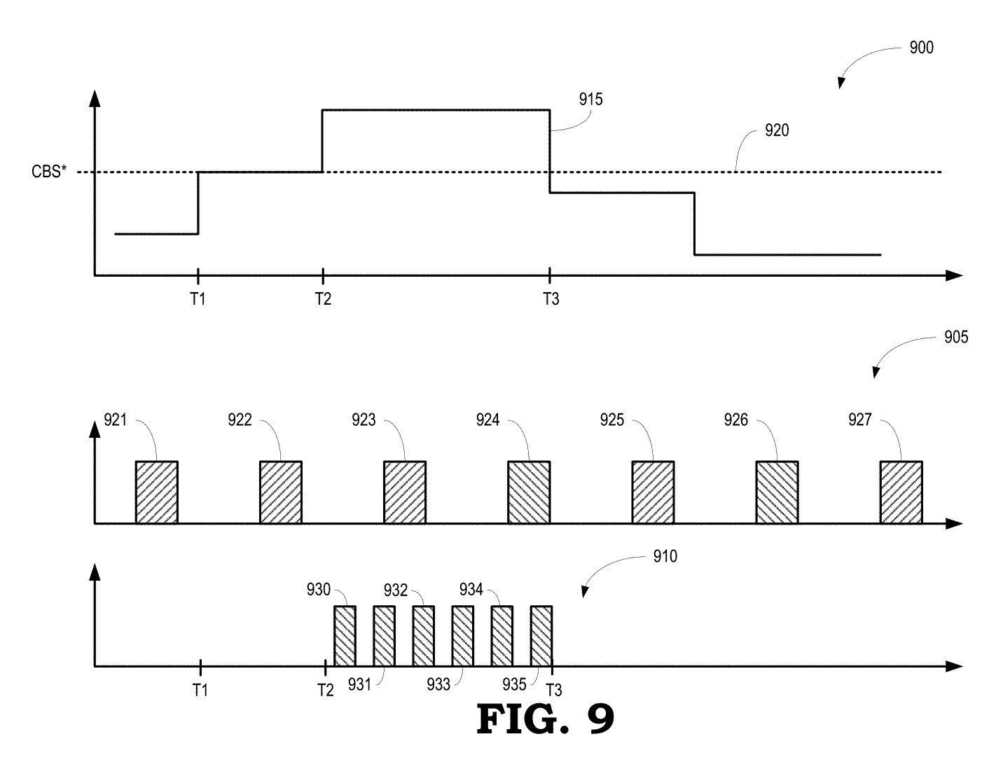

FIG. 9 illustrates a traffic volume profile 900, a series 905 of packet bursts transmitted with CIR, and a series 910 of packet bursts transmitted with EIR as a function of time according to some embodiments. The traffic volume profile 900 illustrates a buffer occupancy 915 of a buffer associated with a traffic shaper, such as the buffer 240 associated with the shaper 235 shown in FIG. 2, the buffer 300 shown in FIG. 3, or the buffer 500 shown in FIG. 5. A threshold 920 indicates the maximum buffer occupancy that can be used to generate CBS-sized packet bursts for transmission using the CIR credit of a backhaul network, as discussed herein. A portion of the buffer has been reserved to store packets in the high-priority packet flows to ensure that the packets in the high-priority traffic flows are marked with the high-priority color for transmission as CBS bursts using the CIR credit, as discussed herein.

At time T<T1, the buffer occupancy 915 is less than the threshold 920 and all the packets received by the buffer in either high-priority traffic flows or low-priority traffic flows can be transmitted in CBS packets that are marked with a high-priority color such as green. For example, a burst 921 is part of the series 905 that is marked with the high-priority color and transmitted using the CIR credit. In the illustrated embodiment, the burst 921 includes packets from a high-priority packet flow such as a voice packet flow, as indicated by the hatching that rises left to right. However, the burst 921 may also include some packets from a low-priority packet flow depending on the packets that are in the buffer when the burst 921 is formed.

At time T1<T<T2, the buffer occupancy 915 is equal to the threshold 920 and all the packets received by the buffer in either high-priority traffic flows or low-priority traffic flows can be transmitted in CBS packets that are marked with a high-priority color such as green. For example, a burst 922 is part of the series 905 that is marked with the high-priority color and transmitted using the CIR credit. In the illustrated embodiment, the burst 922 includes packets from a high-priority packet flow such as a voice packet flow, as indicated by the hatching that rises left to right. However, the burst 922 may also include some packets from a low-priority packet flow depending on the packets that are in the buffer when the burst 922 is formed.

At time T2<T<T3, the buffer occupancy 915 is greater than the threshold 920 and only a subset of the packets received by the buffer in either high-priority traffic flows or low-priority traffic flows can be transmitted in CBS packets that are marked with a high-priority color such as green. The remainder of the packets is transmitted in EBS packets that are marked with a low-priority color such as yellow. However, since a portion of the buffer has been reserved for packets in the high-priority flows, all the high-priority packets are stored in the portion of the buffer that can be transmitted in CBS packets that are marked with a high-priority color. For example, bursts 923, 924 are part of the series 905 that is marked with the high-priority color and transmitted using the CIR credit. Bursts 930, 931, 932, 933, 934, 935 (collectively referred to as “the bursts 930-935”) are part of the series 910 that is marked with the low-priority color and transmitted using the EIR credit. In the illustrated embodiment, the burst 923 includes packets from the high-priority traffic flows and the burst 924 includes packets from the low-priority packet flows, as indicated by the hatching that falls left to right. Moreover, the bursts 930-935 include packets from the low-priority packet flow.

Thus, packets from the high-priority packet flow are all marked with the high-priority color and transmitted in CBS bursts using the CIR credit. None of the packets from the high-priority packet flow are marked with the low-priority color, nor are they transmitted in EBS bursts using the EIR credit. Some of the packets from the low-priority packet flow are marked with the high-priority color and transmitted in CBS bursts using the CIR credit and some of the packets from the low-priority packet flow are marked with the low-priority color and transmitted in EBS bursts using the EIR credit. Routers in the backhaul network preferentially handle packets that are marked with the high-priority color. Reserving a portion of the buffer for the exclusive storage of packets from the high-priority packet flows may reduce or eliminate the loss of high-priority packets during congestion because the high-priority packets have been marked with the high-priority color and transmitted using the CIR credit.

At time T>T3, the buffer occupancy 915 is below the threshold 920 and all the packets received by the buffer in either high-priority traffic flows or low-priority traffic flows can be transmitted in CBS packets that are marked with a high-priority color such as green. For example, bursts 925, 926, 927 are part of the series 905 that is marked with the high-priority color and transmitted using the CIR credit. In the illustrated embodiment, the burst 925 includes packets from a high-priority packet flow, the burst 926 includes packets from a low-priority packet flow, and the burst 927 includes packets from the high-priority packet flow. However, each of the bursts 925-927 may include a mixture of packets from the high-priority and low-priority packet flows depending on the packets that are in the buffer when the bursts 925-927 are formed.

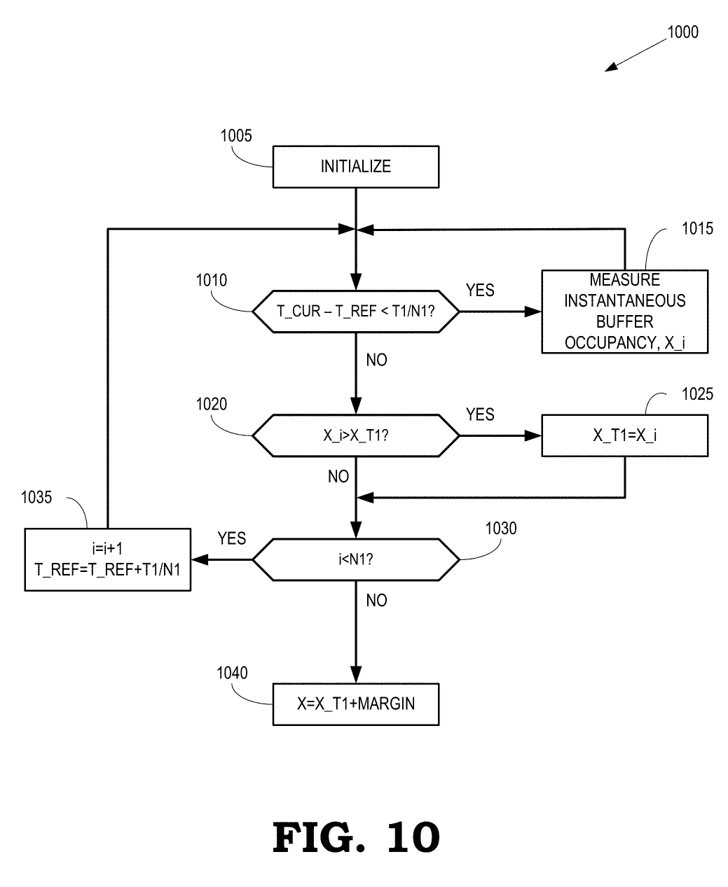

FIG. 10 is a flow diagram of a method 1000 for determining an initial size of a portion of a buffer reserved for packets in high-priority traffic flows according to some embodiments. The method 1000 may be implemented in some embodiments of the shaper 235 shown in FIG. 2 or the traffic shaper 400 shown in FIG. 4.

At block 1005, the shaper initializes the traffic shaping parameters. Some embodiments of the traffic shaping parameters include a reference time (T_REF) that is initialized to be equal to the current time (T_CUR), as well as a CIR, a CBS, a CBS*, an EIR, an EBS, and an EBS* that are initialized based upon an SLA. The value of a predetermined time interval (or warm-up timer) is set to T1, which may be subdivided into N1 measurement sampling subintervals. The variable X, which represents the maximum volume of traffic associated with the high-priority traffic flows (critical traffic) that would need to be stored into the shaper's buffer (240 in FIG. 2 or 300 in FIG. 3) at any given time, is set equal to the threshold CBS*, a counter variable (i) is initialized to 1, and the variable representing the maximum measured buffer occupancy for high-priority traffic flows over the interval T1 (X_T1) is initialized to 0.

At decision block 1010, the shaper determines whether a difference between the current time and the reference time is less than a duration (T1/N1) of the measurement sampling subinterval. If so, the shaper measures the instantaneous buffer occupancy of packets in the high-priority traffic flows (X_i) at block 1015. If the difference is greater than or equal to the duration of the measurement sampling subinterval, which indicates that the measurement period for this iteration of the method 1000 has ended, the shaper determines whether the measured buffer occupancy (X_i) is larger than the maximum measured buffer occupancy over the interval T1 (X_T1) at decision block 1020. If so, the maximum measured buffer occupancy over the interval T1 (X_T1) is set equal to the measured buffer occupancy (X_i) at block 1025. The method then flows to decision block 1030.

At decision block 1030, the shaper determines whether the counter variable (i) is less than the number of measurement sampling subintervals (N1). If so, which indicates that there are additional subintervals in which to perform measurements of the buffer occupancy of the high-priority flows, the shaper increments the counter variable (i) and advances the reference time by an amount equal to the duration of a measurement sampling subinterval (T1/N1) at block 1035. If not, which indicates that the training interval has elapsed, the shaper sets the size of the reserved portion of the buffer for the high-priority traffic flows equal to the maximum buffer occupancy (X_T1) plus a margin (MARGIN) at block 1040.

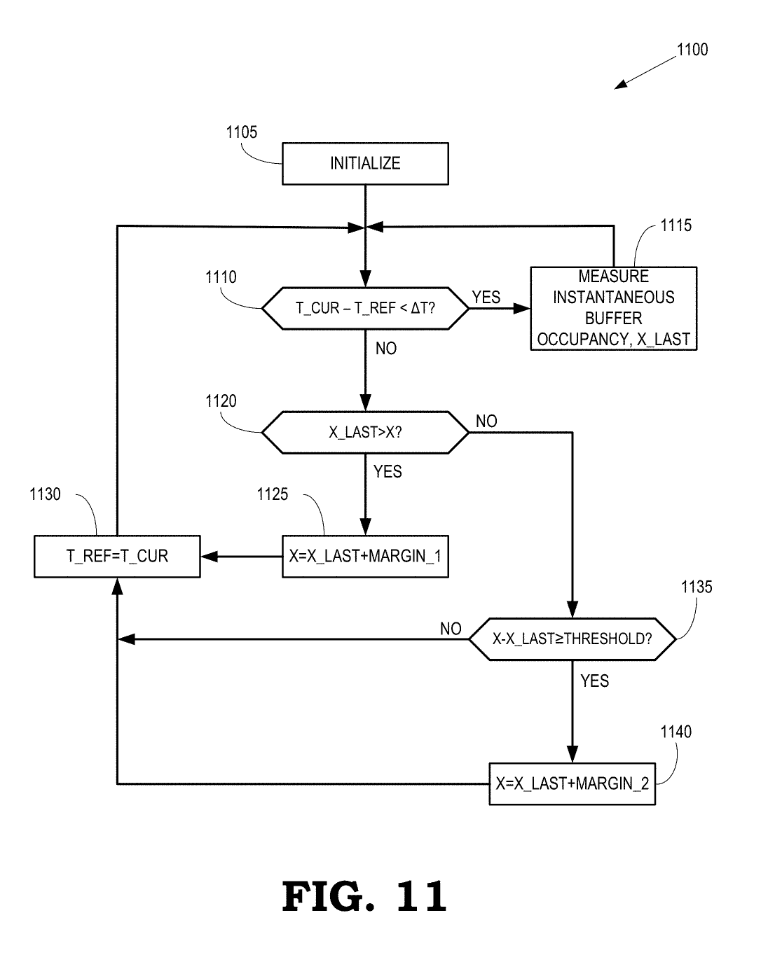

FIG. 11 is a flow diagram of a method 1100 for dynamically modifying a size of a portion of a buffer reserved for packets in high-priority traffic flows according to some embodiments. The method 1100 may be implemented in some embodiments of the shaper 235 shown in FIG. 2 or the traffic shaper 400 shown in FIG. 4. Some embodiments of the method 1100 are performed after an initial training interval to determine an initial size of the portion of the buffer reserved for packets in the high-priority traffic flows, e.g., using embodiments of the method 1000 shown in FIG. 10.

At block 1105, buffer occupancy measurement parameters are initialized. For example, a measurement sampling interval (ΔT) may be initialized to a predetermined time interval and the reference time (T_REF) may be initialized to be equal to the current time (T_CUR).

At decision block 1110, the shaper determines whether a difference between the current time and the reference time is less than the measurement sampling interval (ΔT). If so, the shaper measures the instantaneous buffer occupancy (X_LAST) of packets in the high-priority traffic flows at block 1115. If the difference is greater than or equal to the duration of the measurement sampling interval, which indicates that the measurement period for this iteration of the method 1100 has ended, the shaper determines whether the measured buffer occupancy (X_LAST) is larger than the current size (X) of the reserved portion of the buffer at decision block 1120. If so, the current size of the reserved portion of the buffer (X) is increased to the measured buffer occupancy (X_LAST) plus a first margin (MARGIN_1) at block 1125. The method then flows to block 1130.

If the measured buffer occupancy (X_LAST) is less than the current size of the reserved portion of the buffer (X), the shaper determines (at decision block 1135) whether a difference between the current size (X) and the measured buffer occupancy for the high-priority traffic flows (X_LAST) is greater than or equal to a threshold (THRESHOLD). The threshold is used to provide a hysteresis between increasing and decreasing the size of the reserved portion of the buffer (X). If the difference is greater than or equal to the threshold, the size of the reserved portion of the buffer (X) is decreased to the measured buffer occupancy (X_LAST) plus a second margin (MARGIN_2) at block 1140. The method then flows to block 1130.

At block 1130, the reference time (T_REF) is updated to the current time (T_CUR) and another iteration of the method 1100 is performed by jumping to the block 1110. Iterations of the method 1100 may be performed at periodic intervals or in response to events such as detecting a change in a buffer occupancy, admission of a new call, termination of a call, detecting a change in a number or size of received packets, and the like.

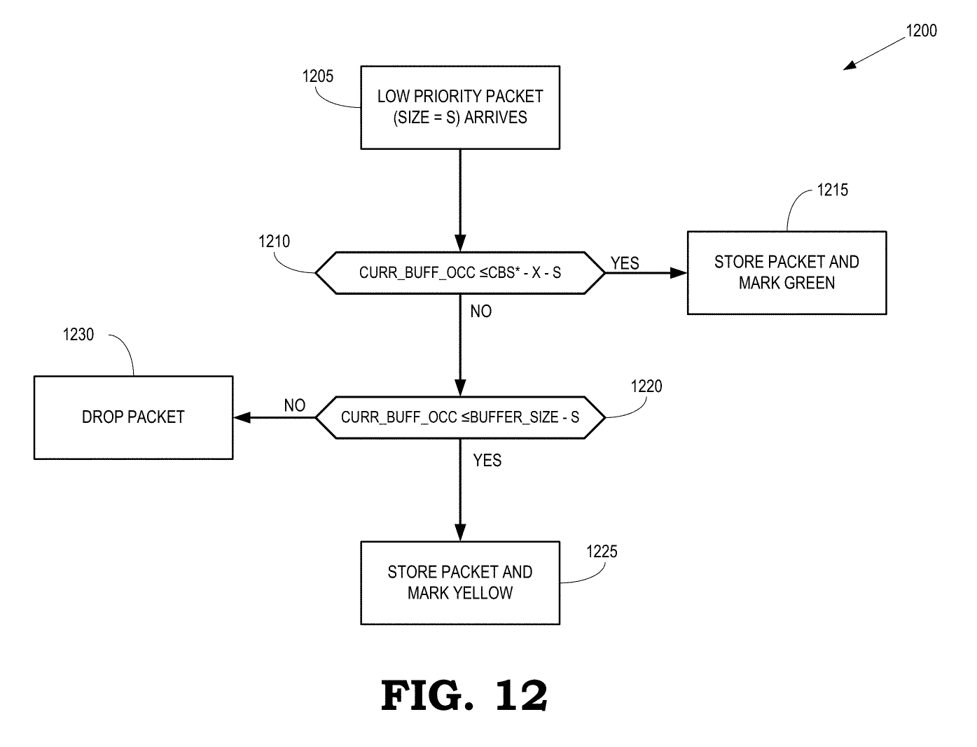

FIG. 12 is a flow diagram of a method 1200 for buffering packets in low-priority traffic flows according to some embodiments. The method 1200 may be implemented in some embodiments of the shaper 235 shown in FIG. 2 or the traffic shaper 400 shown in FIG. 4.

At block 1205, a low-priority packet from a low-priority traffic flow arrives at the traffic shaper. The size of the low-priority packet is S, which may be measured in bits, bytes, or other quantities.

At decision block 1210, the shaper determines whether the current buffer occupancy (CURR_BUFF_OCC) is less than or equal to a difference between a threshold value (CBS*) and the sum of a size (X) of a portion of the buffer reserved for high-priority traffic flows and the size of the low-priority packet, as discussed herein. The threshold value (CBS*) determines the portion of the buffer that is marked with a high-priority color (green, in this embodiment) and used to store packets that are transmitted using CIR resources. If the current buffer occupancy is less than or equal to the difference, which indicates that there is sufficient space in the unreserved CIR portion of the buffer to store the low-priority packet, the low-priority packet is selected and stored in the CIR portion and marked green at block 1215. If the current buffer occupancy is greater than the difference, which indicates that there is not sufficient space in the unreserved CIR portion of the buffer to store the low-priority packet, the method flows to decision block 1220.

At decision block 1220, the shaper determines whether the current buffer occupancy is less than or equal to a difference between the size of the buffer (BUFF_SIZE, represented as 305 in FIG. 3) and the size of the packet (S). If so, which indicates that there is sufficient space left in the buffer to store the packet, the packet is selected and stored in the EIR portion of the buffer and marked with the low-priority color (yellow, in this embodiment) at block 1225. If not, which indicates that there is not sufficient space left in the buffer to store the packet, the packet is dropped at block 1230.

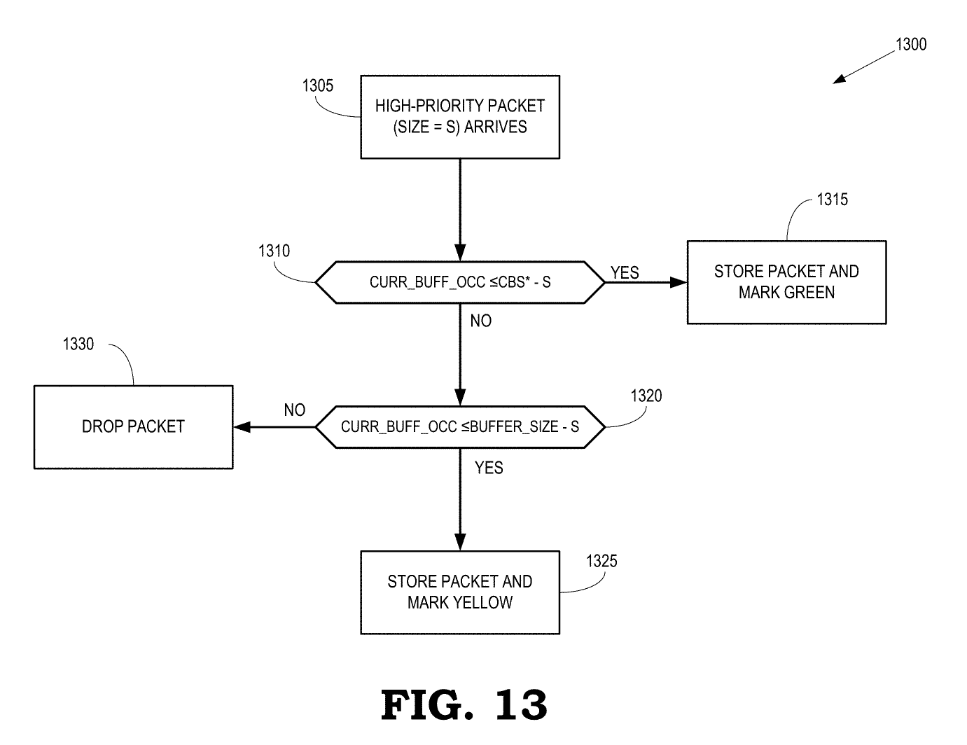

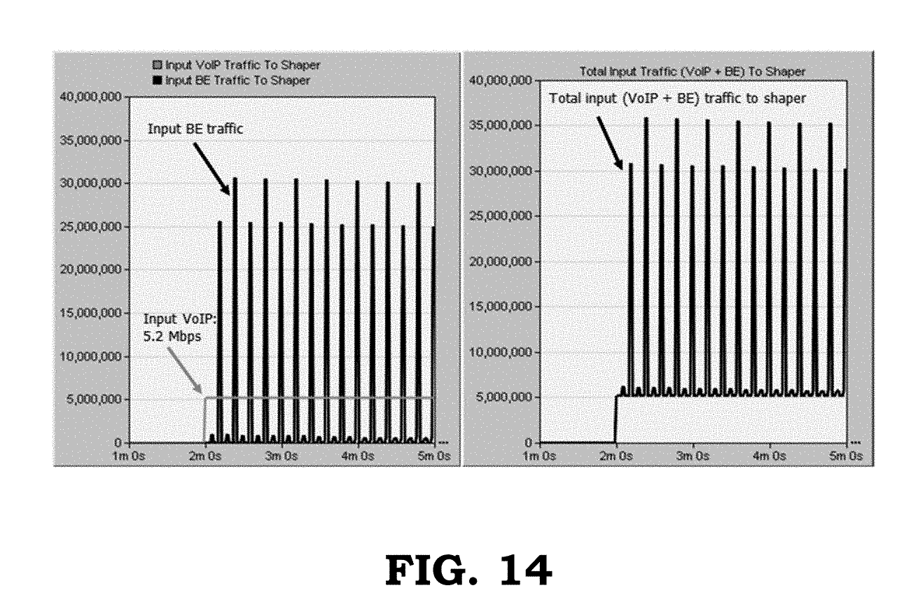

FIG. 13 is a flow diagram of a method 1300 for buffering packets in high-priority traffic flows according to some embodiments. The method 1300 may be implemented in some embodiments of the shaper 235 shown in FIG. 2 or the traffic shaper 400 shown in FIG. 4.

At block 1305, a high-priority packet from a high-priority traffic flow arrives at the traffic shaper. The size of the high-priority packet is S, which may be measured in bits, bytes, or other quantities.

At decision block 1310, the shaper determines whether the current buffer occupancy (CURR_BUFF_OCC) is less than or equal to a difference between a threshold value (CBS*) and a size of the high-priority packet (S), as discussed herein. The threshold value (CBS*) determines the portion of the buffer that is marked with a high-priority color (green, in this embodiment) and used to store packets that are transmitted using CIR resources. If the current buffer occupancy (CURR_BUFF_OCC) is less than or equal to the difference, which indicates that there is sufficient space in the either the reserved or the unreserved CIR portion of the buffer to store the high-priority packet, the high-priority packet is selected and stored in the CIR portion and marked green at block 1315. If the current buffer occupancy (CURR_BUFF_OCC) is greater than the difference, which indicates that there is not sufficient space in the reserved or the unreserved CIR portion of the buffer to store the high-priority packet, the method flows to decision block 1320.

At decision block 1320, the shaper determines whether the current buffer occupancy (CURR_BUFF_OCC) is less than or equal to a difference between the size of the buffer (BUFF_SIZE, represented as 305 in FIG. 3) and the size of the packet (S). If so, which indicates that there is sufficient space left in the buffer to store the packet, the packet is stored in the EIR portion of the buffer and marked with the low-priority color (yellow, in this embodiment) at block 1325. If not, which indicates that there is not sufficient space left in the buffer to store the packet, the packet is dropped at block 1330.

FIG. 14 illustrates high-priority VoIP traffic and low-priority best effort traffic according to some embodiments. The vertical axis in the figures indicates traffic in bits per second and the horizontal axis indicates time. The simulations are performed assuming the following traffic shaping parameters:
CIR=5.35 Mbps, CBS=CBS*=64 KB
EIR=24.65 Mbps, EBS=64 KB, EBS*=0
PIR=CIR+EIR=30 Mbps
   The VoIP traffic is delay sensitive critical traffic and amounts to a volume of 5.2 Mbps, as illustrated in the left-hand figure. The best effort traffic is generated in bursts via UDP traffic and reaches peak values of 30 Mbps. The right-hand figure indicates the total input traffic to the traffic shaper. The total input traffic combines VoIP and best effort traffic and can reach 35 Mbps at peaks, which is above the total allowed information rate or peak information rate (PIR) at the output of the traffic shaper. The PIR may be established by an SLA.

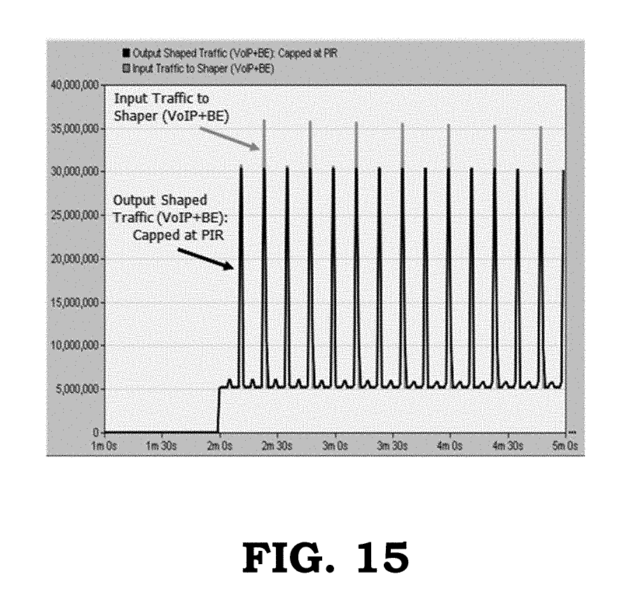

FIG. 15 illustrates traffic shaping of high-priority VoIP traffic and low-priority best effort traffic using a buffer that does not reserve space exclusively for the high-priority VoIP traffic according to some embodiments. The vertical axis in the figures indicates traffic in bits per second and the horizontal axis indicates time. The simulations are performed assuming the same traffic shaping parameters as in FIG. 14. The input traffic is a combination of the VoIP traffic and the best effort traffic. The total information rate input to the traffic shaper exceeds the PIR in several of the bursts. The traffic shaper therefore caps the total traffic at the allowed PIR to generate the output shaped traffic.

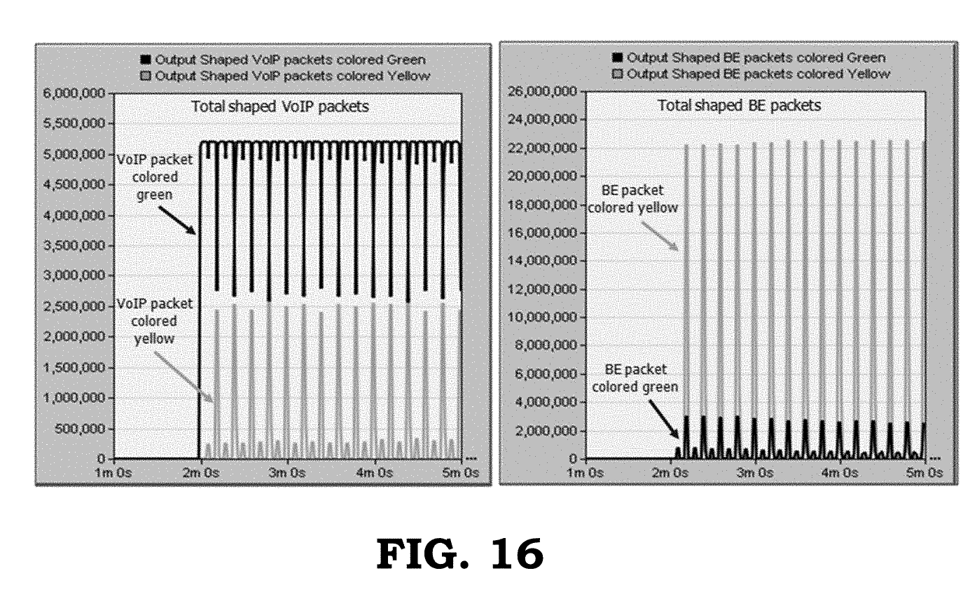

FIG. 16 illustrates the total numbers of shaped high-priority VoIP packets and low-priority best effort packets output from a traffic shaper that uses a buffer that does not reserve space exclusively for the high-priority VoIP traffic according to some embodiments. The vertical axis in the figures indicates traffic in bits per second and the horizontal axis indicates time. The simulations are performed assuming the same traffic shaping parameters as in FIG. 14. The left-hand plot shows that nearly half of the high-priority VoIP packets are marked with the low-priority color when the total information rate input to the traffic shaper exceeds the PIR, as indicated in FIG. 15. The right-hand plot shows that approximately 10% of the low-priority best effort packets are marked with a high-priority color when the total information rate input to the traffic shaper exceeds the PIR, as indicated in FIG. 15.

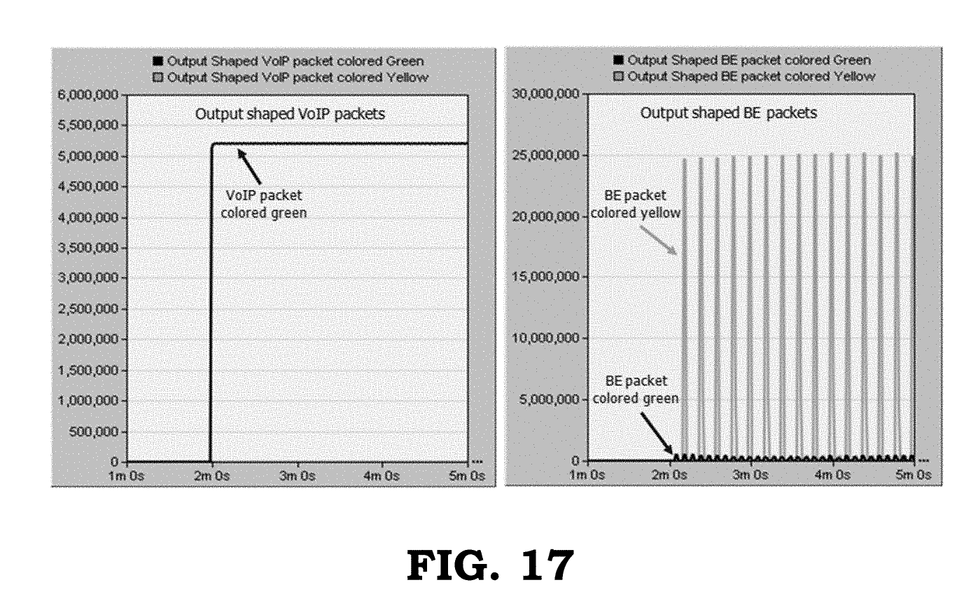

FIG. 17 illustrates the total numbers of shaped high-priority VoIP packets and low-priority best effort packets output from a traffic shaper that uses a buffer that reserves space exclusively for the high-priority VoIP traffic according to some embodiments (X=2 KB in this example, where X is defined as in the flowcharts in FIGS. 10 and 11). The vertical axis in the figures indicates traffic in bits per second and the horizontal axis indicates time. The simulations are performed assuming the same traffic shaping parameters as in FIG. 14. The left-hand plot shows that substantially all of the high-priority VoIP packets are marked with the high-priority color, even during intervals when the total information rate input to the traffic shaper exceeds the PIR, as indicated in FIG. 15. The right-hand plot shows that an almost negligible percentage of the low-priority best effort packets are marked with a high-priority color when the total information rate input to the traffic shaper exceeds the PIR, as indicated in FIG. 15. Consequently, the likelihood that any of the high-priority VoIP may be dropped during intervals of congestion in the network (102 in FIG. 1) is reduced or eliminated by reserving space in the buffer explicitly for the high-priority VoIP packets and marking these packets with the high-priority color.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
selecting, from at least one traffic flow, only packets in at least one high-priority traffic flow and storing the selected packets in a first portion of a buffer, wherein a size of the first portion is determined based on an estimated maximum volume of traffic in the at least one high-priority traffic flow;
storing packets in either the at least one high-priority traffic flow or at least one low-priority traffic flow in a second portion of the buffer;
storing only packets in the at least one low-priority traffic flow in a third portion of the buffer;
marking the packets in the first portion and the second portion with a high-priority color; and
marking the packets in the third portion with a low-priority color.

2. The method of claim 1, further comprising:
determining the size of the first portion based on packets received in the at least one high-priority traffic flow within a previous time interval.

3. The method of claim 2, wherein determining the size of the first portion comprises determining the size of the first portion based on a sum over the at least one high-priority traffic flow of a product of a maximum number of packets and the size of the packets received in the at least one high-priority traffic flow within the previous time interval.

4. The method of claim 2, wherein determining the size of the first portion comprises determining the size of the first portion based on a maximum value of a plurality of buffer storage capacities used by the at least one high-priority traffic flow in a plurality of subintervals of the previous time interval.

5. The method of claim 1, further comprising:
modifying the size of the first portion in response to a change in a measured value of a buffer storage capacity used by the at least one high-priority traffic flow.

6. The method of claim 5, wherein modifying the size of the first portion comprises decreasing the size of the first portion to the measured value plus a first margin in response to the measured value being less than a previously measured value of the buffer storage capacity.

7. The method of claim 5, wherein modifying the size of the first portion comprises increasing the size of the first portion to the measured value plus a second margin in response to the measured value being greater than a previously measured value of the buffer storage capacity.

8. The method of claim 1, further comprising:
transmitting marked packets from the first portion and the second portion of the buffer in a burst determined by a committed information rate and a committed burst size; and
transmitting marked packets from the third portion of the buffer in a burst determined by an excess information rate and an excess burst size.

9. An apparatus comprising:
a buffer to store only packets in at least one high-priority traffic flow in a first portion, wherein the size of the first portion is determined based on an estimated maximum volume of traffic in the at least one high-priority traffic flow, wherein the buffer is to store packets in either the at least one high-priority traffic flow or at least one low-priority traffic flow in a second portion, and wherein the buffer is to store only packets in the at least one low-priority traffic flow in a third portion; and
a processor to mark the packets in the first portion and the second portion with a high-priority color prior to transmission of the packets and to mark the packets in the third portion with a low-priority color prior to transmission of the packets.

10. The apparatus of claim 9, wherein the processor is to determine the size of the first portion based on packets received in the at least one high-priority traffic flow within a previous time interval.

11. The apparatus of claim 10, wherein the processor is to determine the size of the first portion based on a sum over the at least one high-priority traffic flow of a product of a maximum number of packets and the size of the packets received in the at least one high-priority traffic flow within the previous time interval.

12. The apparatus of claim 10, wherein the processor is to determine the size of the first portion based on a maximum value of a plurality of buffer storage capacities used by the at least one high-priority traffic flow in a plurality of subintervals of the previous time interval.

13. The apparatus of claim 9, wherein the processor is to modify the size of the first portion in response to a change in a measured value of a buffer storage capacity used by the at least one high-priority traffic flow.

14. The apparatus of claim 13, wherein the processor is to decrease the size of the first portion to the measured value plus a first margin in response to the measured value being less than a previously measured value of the buffer storage capacity.

15. The apparatus of claim 13, wherein the processor is to increase the size of the first portion to the measured value plus a second margin in response to the measured value being greater than a previously measured value of the buffer storage capacity.

16. The apparatus of claim 9, further comprising:
a transceiver to transmit marked packets from the first portion and the second portion of the buffer in a burst determined by a committed information rate and a committed burst size and to transmit marked packets from the third portion of the buffer in a burst determined by an excess information rate and an excess burst size.

17. A non-transitory computer readable medium embodying a set of executable instructions, the set of executable instructions to manipulate at least one processor to:
select, from at least one traffic flow, only packets in at least one high-priority traffic flow and store the selected packets in a first portion of a buffer, wherein the size of the first portion is determined based on an estimated maximum volume of traffic in the at least one high-priority traffic flow;
store packets in either the at least one high-priority traffic flow or at least one low-priority traffic flow in a second portion of the buffer;
store only packets in the at least one low-priority traffic flow in a third portion of the buffer;
mark the packets in the first portion and the second portion with a high-priority color prior to transmission of the packets; and
mark the packets in the third portion with a low-priority color prior to transmission of the packets.

18. The non-transitory computer readable medium of claim 17, wherein the set of executable instructions is to manipulate the at least one processor to:
determine the size of the first portion based on packets received in the at least one high-priority traffic flow within a previous time interval.

19. The non-transitory computer readable medium of claim 17, wherein the set of executable instructions is to manipulate the at least one processor to:
modify the size of the first portion in response to a change in a measured value of a buffer storage capacity used by the at least one high-priority traffic flow.

20. The non-transitory computer readable medium of claim 17, wherein the set of executable instructions is to manipulate the at least one processor to:
transmit marked packets from the first portion and the second portion of the buffer in a burst determined by a committed information rate and a committed burst size; and
transmit marked packets from the third portion of the buffer in a burst determined by an excess information rate and an excess burst size.
